(19) United States
(12) Patent Application Publication
(10) Pub. No.: US 2015/0134446 A1
(43) Pub. Date: May 14, 2015

(54) SYSTEM FOR PROVIDING CONTENT-BASED CONTEXTUAL ADVERTISING IN EMAlL

(71) Applicant: ReachDynamics, LLC, St. Louis, MO (US)

(72) Inventor: Eric L. Castelli, Columbia, IL (US)

(21) Appl. No.: 14/533,816

(22) Filed: Nov. 5, 2014

Related U.S. Application Data
(60) Provisional application No. 61/901,654, filed on Nov. 8, 2013.

(51) Int. Cl. G06Q 30/02

(52) U.S. Cl. CPC G06Q 30/0251
USPC 705/14.49

(57) ABSTRACT

The system and methods for providing content-based contextual advertising in email provided herein overcome the inherent challenge of manually or programmatically inserting content-relevant advertising by proving a simply method to capture, store and analyze email creative for dynamic advertisement rendering.

### CROSS-REFERENCE TO RELATED APPLICATIONS

This application claims the benefit of U.S. Provisional Application No. 61/901,654, filed on Nov. 8, 2013, the entire disclosure of which is incorporated herein by reference.

### FIELD OF INVENTION

The present disclosure relates generally to the display of advertisements in email, and more particularly, systems and methods for dynamically displaying advertising content in email based on the content of the email itself.

### BACKGROUND OF THE INVENTION

As technology has evolved, so has online advertising. Initially, advertisements on web sites were static. They were simply HTML snippets web site owners placed on web pages which included a static image and static URL. Over time, new services like Google AdSense came about which leveraged dynamic scripting technologies like JavaScript that allowed for the dynamic rotation of advertisements. Around the same time, it was determined that showing advertisements on web pages which related to the content of the page improved performance of the advertisements. This in turn, was the beginning of contextual online advertising.

In web-based contextual advertising, spiders, or web crawlers, visit the web pages which ads are displayed on. The content is then stored and indexed and when users visit the page, the text of the page is used in determining ads to display which are relevant to the content.

However, trying to apply the same contextual techniques to email advertising presents a number of challenges due to essential differences between email and other Internet content. For one, email is static in nature. Unlike web sites which support scripting technologies like JavaScript, email does not support dynamic scripting of content. The HTML and text of an email cannot be changed once sent and thus in order to display advertisements in email these advertisements must be statically placed. In addition, unlike web pages which have a fixed and known method of accessing their content (i.e., a URL), only the sender or the recipient of the email may view the content of an email.

One way to insert advertisements in email which are related to the content is for the email sender to manually change the HTML of their emails each time they send to insert advertisements relevant to the content. However, this process is impractical and inefficient for the mail sender.

Some would suggest the best way to insert contextually relevant advertisements would be to programmatically intercept email as it is transmitted, analyze the content, and dynamically insert static HTML for relevant ads.

However, such a mechanism has numerous flaws. First, there is no universal method to intercept outbound email and change its content. There are hundreds if not thousands of mail sending MTAs and ESPs, and writing code to integrate with each provider's protocol would be a tremendous undertaking. Further, having the ability alter any part of the content of outbound mail introduces tremendous security risks including the risk of intercepting personal information or potentially altering content in a nefarious manner. Finally, while using the content of the message to serve relevant ads increases performance, dynamically altering the ads displayed based on the user viewing (such as displaying ads specific to the type of device the user is using) is also important. If advertisements are written at the time the mail is sent, there is no way to alter ad content based on these additional contextual variables. Therefore, there is a need for providing content-based contextual advertising in email.

### SUMMARY OF THE INVENTION

In one aspect, the present disclosure provides a method for providing contextual advertising in an email, including: providing, using one or more computing devices, an ad unit identifier corresponding to an ad unit in an email to a user; providing, using one or more computing devices, a campaign identifier corresponding to a template associated with the email to the user; generating, using the one or more computing devices, an ad image load request when the user views the email, the ad image load request including the ad unit identifier, the campaign identifier, and at least one user identifier; retrieving, using the one or more computing devices, an ad image corresponding to the ad unit identifier in response to the ad unit image load request, the ad image dynamically selected from a pool of available advertisement images corresponding to the ad unit based on the campaign identifier and user identifier; displaying, using the one or more computing devices, the ad image in the email; recording, using the one or more computing devices, the ad image and at least one user identifier in an impression data store.

In another aspect, the present disclosure provides a method further including: storing, using the one or more computing devices, the ad unit and ad unit information in a data store; and storing, using the one or more computing devices, the template in the data store, where the ad unit includes at least two advertisements. The method may further include: retrieving, using the one or more computing devices, the template corresponding to the campaign identifier; analyzing, using the one or more computing devices, the template to identify one or more keywords; and storing, using the one or more computing devices, the one or more keywords in the data store, where the keywords inform the dynamic selection of the ad image from the ad unit. In another aspect, the method may further include: providing, using the one or more computing devices, an online email URL associated with an online viewable email corresponding to the email to the user; storing, using the one or more computing devices, the ad unit and ad unit information in a data store; and storing, using the one or more computing devices, the online viewable email in the data store, where the ad unit includes at least two advertisements. In yet another aspect, the method may further include: retrieving, using the one or more computing devices, the online viewable email associated with the online email identifier; analyzing, using the one or more computing devices, the online viewable email to identify one or more keywords; and storing, using the one or more computing devices, the one or more keywords in the data store, where the keywords inform the dynamic selection of the ad image from the ad unit.

The method may further include: retrieving, using the one or more computing devices, a redirect URL corresponding to the ad image; and returning, using the one or more computing devices, the redirect URL to the user. In another aspect, the method may further include: retrieving, using the one or more computing devices, an email service provider from a publisher for the template; and storing, using the one or more computing devices, the email service provider of the publisher in the data store. The method may further include: retrieving a lookup URL from the publisher; and retrieving the template from the lookup URL when the email service provider is unknown. In an aspect, the ad unit information is selected from size of the advertisements, number of advertisements, types of advertisements, specific advertisements, ad images, ad colors, ad layouts, negative keyword targets, and combinations thereof. The method may further include providing, using one or more computing devices, a recipient identifier corresponding to the user. The method may further include creating an ad unit code including at least one of the ad unit identifier, the campaign identifier, and the recipient identifier. In another aspect, at least one user identifier is selected from an impression date, an impression time, a user IP address, a user agent, a user device, a user email address, a derivative of the user email address, a user location, a randomly generated number, a randomly generated variable, and combinations thereof. In an aspect, the template includes a subject line, an HTML portion, a text portion, and any combination thereof.

In another aspect, the present disclosure provides a system for providing contextual advertising in an email, including: at least one processor, a dynamic ad application including a plurality of modules executable on at least one processor, the plurality of modules including: an image load request module to identify an ad unit image load request generated by a user viewing the email, the ad image load request including an ad unit identifier corresponding to an ad unit, a campaign identifier corresponding to a template associated with the email to the user, and at least one user identifier; a dynamic ad unit lookup module to retrieve an ad image corresponding to the ad unit identifier in response to the ad unit image load request, the ad image dynamically selected from a pool of available advertisement images corresponding to the ad unit based on the campaign identifier and user identifier; an image serving module to display the ad image to the user; and an impression recording module for identifying the ad image displayed to the user and recording the ad image and at least one user identifier in an impression data store.

In another aspect, the present disclosure provides the plurality of modules further include: an ad unit definition module including a data store for storing the ad unit and ad unit information; a unique identifier module for assigning the ad unit identifier to the ad unit, assigning the campaign identifier to the template, and storing the ad unit identifier and campaign identifier in the data store; and a campaign module for storing the template in the data store. The plurality of modules further include: a template module for retrieving the template corresponding to the campaign identifier; a crawling module for analyzing the template to identify one or more keywords; and a creative module for storing the one or more keywords in the data store, where the keywords inform the dynamic selection of the ad image from the ad unit. The ad image load request further includes an online email URL associated with to an online viewable email corresponding to the email; an online email module for retrieving the online viewable email associated with the online email URL; and the plurality of modules further include: a crawling module for analyzing the online viewable email to identify one or more keywords; and a creative module for storing the one or more keywords in the data store, where the keywords inform the dynamic selection of the ad image from the ad unit. The plurality of modules further include: a redirection lookup module for retrieving a redirect URL corresponding to the ad image; and a redirection return module for returning the redirect URL to the user. The plurality of modules further includes: an ESP module for retrieving an email service provider from a publisher for the template; and an ESP storage module for storing the email service provider of the publisher in the data store.

The plurality of modules further includes: a lookup module for retrieving a lookup URL from the publisher; and a template lookup module for retrieving the template from the lookup URL when the email service provider is unknown. The ad unit information is selected from size of the advertisements, number of advertisements, types of advertisements, specific advertisements, ad images, ad colors, ad layouts, negative keyword targets, and combinations thereof. The unique identifier module further includes assigning a recipient identifier corresponding to the user. The plurality of modules further includes an ad unit code module for creating an ad unit code including at least one of the ad unit identifier, the campaign identifier, and the recipient identifier. In various aspects, at least one user identifier is selected from an impression date, an impression time, a user IP address, a user agent, a user device, a user email address, a derivative of the user email address, a user location, a randomly generated number, a randomly generated variable, and combinations thereof. In an aspect, the template includes a subject line, an HTML portion, a text portion, and any combination thereof.

### BRIEF DESCRIPTION OF THE DRAWINGS

FIG. 1 is a flow diagram of the content-based contextual advertising method 100 in one aspect.

FIG. 2 is a schematic of the content-based contextual advertising system 200 in one aspect.

FIG. 3 is a schematic overview of a process overview of the system for providing content-based contextual advertising in email.

### DETAILED DESCRIPTION

Provided herein is a simple mechanism for programmatically examining the text of an email message and using this content to dynamically display relevant advertisements. This, in turn, allows for customizing the exact advertisements being displayed to the user real time, which provides for better relevancy to the user and ultimately improves ad performance.

### A. Methods of Content-Based Contextual Advertising

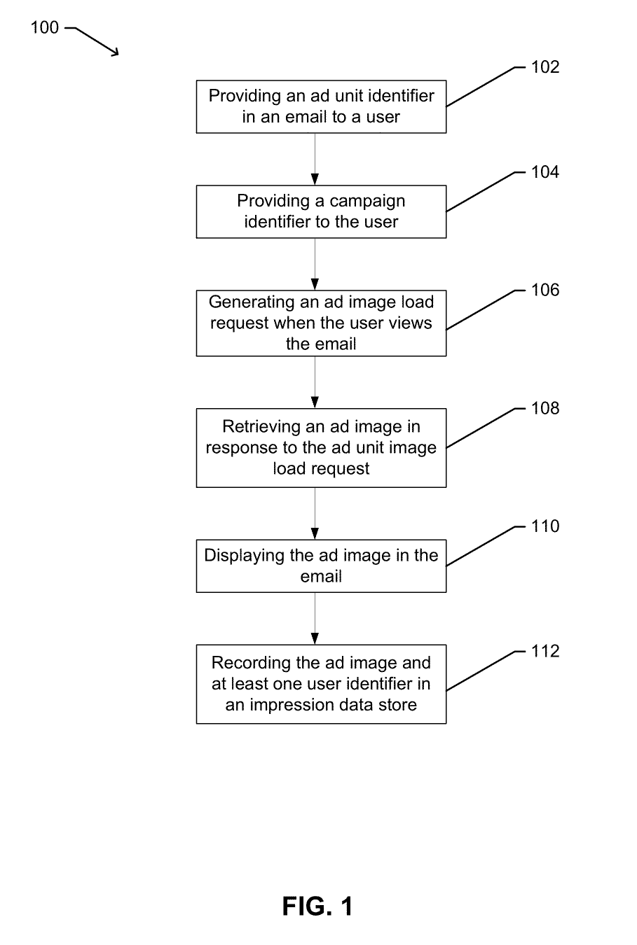

FIG. 1 is a flow diagram of the content-based contextual advertising method 100 in one aspect. In an aspect, the method for providing contextual advertising in an email may include providing an ad unit identifier in an email to a user at step 102; providing a campaign identifier to the user at step 104; generating an ad image load request when the user views the email at step 106; retrieving an ad image in response to the ad unit image load request at stem 108; displaying the ad image in the email at step 110; recording the ad image and at least one user identifier in an impression data store at step 112.

In an aspect, the ad unit identifier may correspond to an ad unit. The ad unit may include one or more ad images and data associated with an advertiser. In various aspects, the ad image may be an image wrapped in a URL. Non-limiting examples of image formats include JPEG, PNG, GIF, TIFF, BMP, WEBP, or any file format capable of rendering an image. The campaign identifier is an index that may correspond to a template associated with the email. In an aspect, the campaign identifier may be a number, keyword, any unique identifier for a campaign, and combinations thereof. The ad image load request may include the ad unit identifier, the campaign identifier, and at least one user identifier. The ad unit identifier is an index that may be used to locate an ad unit on computing device, for example on a server. In an aspect, the ad unit identifier may be a number, keyword, or combinations thereof. The user identifier is an index that may be used to identify specific recipient of email. In an aspect, the user identifier may be a number, keyword, email address, username, server ID, or any other unique identifier of the user. In an aspect, the ad image may correspond to the ad unit identifier. The ad image may be dynamically selected from a pool of available advertisement images corresponding to the ad unit based on the campaign identifier and user identifier. In an aspect, the ad image displayed may be selected by dynamic selection, sequential selection, or impression data selection. Dynamic selection may use any known method for selection including random selection. Selection in sequential order may be based on known previous views by the user. Selection according to other impression data may include including time of day, location of user, or any other user attributes.

In another aspect, method may further include storing the ad unit and ad unit information in a data store and storing the template in the data store. In an aspect, the ad unit may include at least two advertisements. In various aspects, the ad unit may include but is not limited to 2 to 10 advertisements, 5 to 15 advertisements, 10 to 20 advertisements, or 15 to 30 advertisements. The method may further include retrieving the template corresponding to the campaign identifier; analyzing the template to identify one or more keywords; and storing the one or more keywords in the data store. The template may be may be provided by the publisher, either through the email service provider (ESP) or a link to view the creative online. In an aspect, the keywords may inform the dynamic selection of the ad image from the ad unit. In another aspect, the method may further include providing an online email URL associated with an online viewable email corresponding to the email to the user; storing the ad unit and ad unit information in a data store; and storing the online viewable email in the data store, where the ad unit may include at least two advertisements. In yet another aspect, the method may further include retrieving the online viewable email associated with the online email identifier; analyzing the online viewable email to identify one or more keywords; and storing the one or more keywords in the data store, where the keywords inform the dynamic selection of the ad image from the ad unit.

In another aspect, the method may further include retrieving a redirect URL corresponding to the ad image and returning the redirect URL to the user. The redirect URL corresponds to the ad image clicked by the user, so that the user is directed to the appropriate URL for the image they clicked. In another aspect, the method may further include retrieving an email service provider from a publisher for the template and storing the email service provider of the publisher in the data store. The method may further include retrieving a lookup URL from the publisher and retrieving the template from the lookup URL when the email service provider is unknown. In an aspect, the ad unit information may include but is not limited to size of the advertisements, number of advertisements, types of advertisements, specific advertisements, ad images, ad colors, ad layouts, negative keyword targets, and combinations thereof. The method may further include providing a recipient identifier corresponding to the user. In an aspect, the method may further include creating an ad unit code including at least one of the ad unit identifier, the campaign identifier, and the recipient identifier. In another aspect, at least one user identifier may include but is not limited to an impression date, an impression time, a user IP address, a user agent, a user device, a user email address, a derivative of the user email address, a user location, a randomly generated number, a randomly generated variable, and combinations thereof. In an aspect, the template may include but is not limited to a subject line, an HTML portion, a text portion, and any combination thereof.

### B. Systems for Content-Based Contextual Advertising

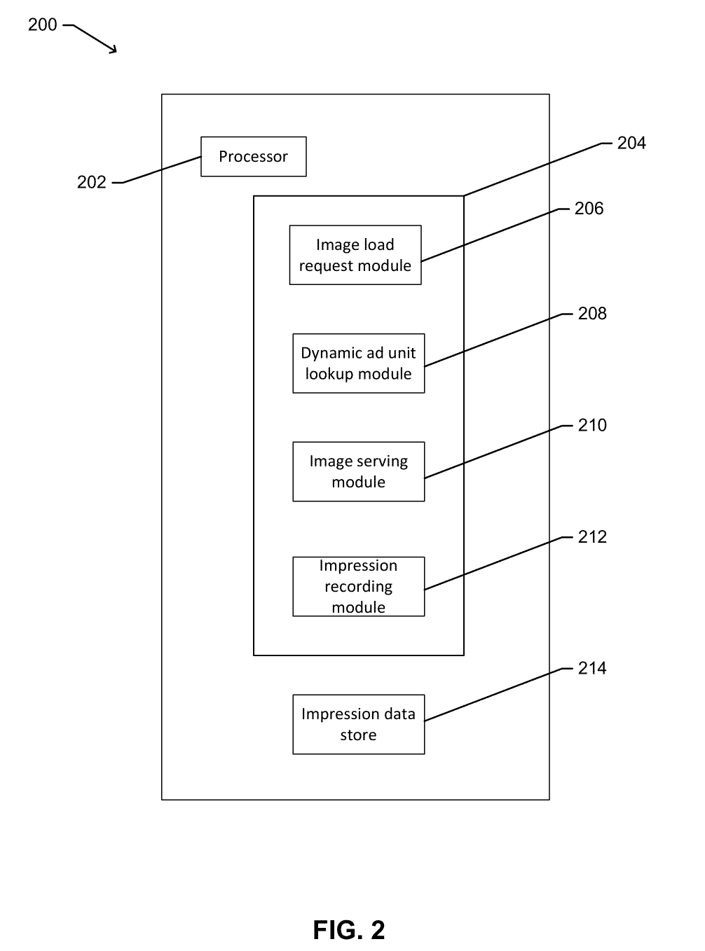

FIG. 2 is a schematic of the content-based contextual advertising system 200 in one aspect. In an aspect, the system for providing dynamic ad serving in an email may include at least one processor 202 and a dynamic ad application 204 including a plurality of modules executable on at least one processor. The plurality of modules may include an image load request module 206; a dynamic ad unit lookup module 208; an image serving module 210; and an impression recording module 212.

In another aspect, the image load request module may identify an ad unit image load request generated by a user viewing the email. In an aspect, the ad image load request may include but is not limited to an ad unit identifier corresponding to an ad unit, a campaign identifier corresponding to a template associated with the email to the user, and at least one user identifier. The dynamic ad unit lookup module may retrieve an ad image corresponding to the ad unit identifier in response to the ad unit image load request. In an aspect, the ad image may be dynamically selected from a pool of available advertisement images corresponding to the ad unit based on the campaign identifier and user identifier. The image serving module may display the ad image to the user. In an aspect, the impression recording module may identify the ad image displayed to the user and record the ad image and at least one user identifier in an impression data store 214.

In another aspect, the plurality of modules may further include an ad unit definition module including a data store for storing the ad unit and ad unit information; a unique identifier module for assigning the ad unit identifier to the ad unit, assigning the campaign identifier to the template, and storing the ad unit identifier and campaign identifier in the data store; and a campaign module for storing the template in the data store. The plurality of modules may further include a template module for retrieving the template corresponding to the campaign identifier; a crawling module for analyzing the template to identify one or more keywords; and a creative module for storing the one or more keywords in the data store. In an aspect, the keywords may inform the dynamic selection of the ad image from the ad unit. In another aspect, the ad image load request may further include an online email URL associated with to an online viewable email corresponding to the email and an online email module for retrieving the online viewable email associated with the online email URL. In this aspect, the plurality of modules may further include a crawling module for analyzing the online viewable email to identify one or more keywords and a creative module for storing the one or more keywords in the data store. In various aspects, the keywords may inform the dynamic selection of the ad image from the ad unit. The plurality of modules may further include a redirection lookup module for retrieving a redirect URL corresponding to the ad image and a redirection return module for returning the redirect URL to the user. In another aspect, the plurality of modules may further include an ESP module for retrieving an email service provider from a publisher for the template and an ESP storage module for storing the email service provider of the publisher in the data store.

The plurality of modules may further include a lookup module for retrieving a lookup URL from the publisher and a template lookup module for retrieving the template from the lookup URL when the email service provider is unknown. The ad unit information may include but is not limited to size of the advertisements, number of advertisements, types of advertisements, specific advertisements, ad images, ad colors, ad layouts, negative keyword targets, and combinations thereof. In an aspect, the unique identifier module may further include assigning a recipient identifier corresponding to the user. The plurality of modules may further include an ad unit code module for creating an ad unit code including at least one of the ad unit identifier, the campaign identifier, and the recipient identifier. In various aspects, at least one user identifier may include but is not limited to an impression date, an impression time, a user IP address, a user agent, a user device, a user email address, a derivative of the user email address, a user location, a randomly generated number, a randomly generated variable, and combinations thereof. In an aspect, the template may include but is not limited to a subject line, an HTML portion, a text portion, and any combination thereof.

### EXAMPLES

The following examples are provided for exemplary guidance to use the system and methods according to the inventive subject matter. However, it should be recognized that numerous modifications may be made without departing from the inventive concept presented herein.

### Example 1

### Content-Based Contextual Advertising

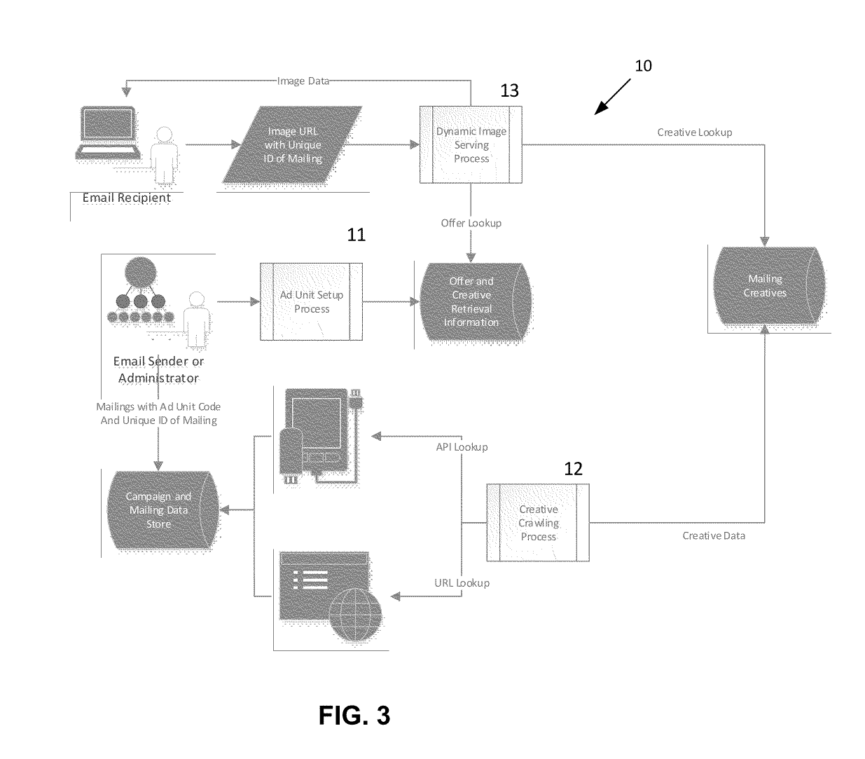

FIG. 3 illustrates the methods and system 10 for providing content-based contextual advertising in email. In an aspect, the method may include an ad unit setup process 11, a creative crawling process 12, and a dynamic image serving process 13. Generally, the system 10 and methods may allow for the definition of ad units 11 or placeholders for advertisements in email. The creative crawling process 12 may be responsible for retrieving the “template” creative for each email and cataloging and storing the creative in a central data store. The dynamic image serving process 13 may be responsible for responding to ad unit image load requests and returning relevant image advertisements based on the email creative attributes stored by the creative crawling process 12 as well as additional contextual criteria.

### Example 2

### Ad Unit Setup

In the ad unit set up process 11, an email publisher or an administrator defines an ad unit. An ad unit is a placeholder for where an advertisement should be displayed in an email much like that defined in typical web-based advertising services look Google AdSense. During the ad unit setup process, the publisher may define information about the ad unit, such as the size of the ad unit and the types of advertisements to display or in some embodiments, specific ads which may be displayed.

When defining an ad unit in the ad unit set up process 11, the email publisher or administrator will be asked the type of mail service they use. A pre-defined list of enabled Email Service Providers (ESPs) with which the service integrates via API with will be provided. In addition, an “Other” option will be provided. If the user selects a pre-defined ESP, the user's API credentials will be requested during this process. The format of these credentials will differ based on the ESP but typically will be an account-specific API Key or OAuth keys collected through the ESP's OAuth authentication process. This information is then stored and associated with the ad unit. In the case the email publisher or administrator chooses “Other” during the setup process, then a lookup URL may be input and recorded which allows for the variable insertion of a campaign Id or mailing Id as in the example below:
http://mailercreativelookup.com/LookupCampaignId=[[Id]]

Once created, the ad unit information is stored in a data store for later retrieval. HTML code for the ad unit is then provided to the email sender for insertion into their email templates. One or more identifiers may then be included in the ad unit code, which when combined create a unique identifier of the ad unit. Additionally, depending on the ESP the user selected during the ad unit set up process, the code will be pre-populated with placeholder variables supported by the specific ESP. Minimally this would include a placeholder variable that is automatically populated by the ESP as email is sent which includes a unique identifier of the mailing or campaign. Additionally, this may include other variables, including variables which identify the recipient, either by email or other unique identifier. An example of this HTML code for one ESP may appear as follows:
<a href=“http://e-find.co/c/1?CampaignId=[[CampaignId]]&EmailId=[[EmailId]]”><img src=“http://e-find.co/img/1?CampaignId=[[CampaignId]]&EmailId=[[EmailId]]”/></a>

In this example, the number “1” in the ad unit HTML code is used to uniquely identify the specific ad unit when image loads and clicks occur in the emails the ad unit is inserted into. The “[[CampaignId]]” variable is a placeholder which the ESP automatically populates as mail is sent with a unique identifier for the particular campaign or mailing. In general, this number is not unique to every email sent but instead unique to the “template” used to send the mailing which defines the subject line, HTML and text content. Further, in this example the [[EmailId]] variable is a placeholder which the ESP automatically populates as mail is sent with a unique identifier for the recipient.

In the case that the email publisher or administrator does not send mail using a supported ESP and selected “Other” in the ad unit set up process, 11, placeholders will be provided and instructions given on how a unique campaign Id must be inserted into the ad unit code. The code would be much the same as the previous example but the email publisher would have to ensure the appropriate variables are inserted depending on how their underlying mail system functions.

### Example 3

### Creative Crawling

The creative crawling process, 12, is responsible for retrieving, storing and cataloging email creatives. The email creative may be provided by the publisher, either through the email service provider (ESP) or a link to view the creative online. In the case that an ad unit was set up for a supported ESP, the ESP's APIs are leveraged to authenticate using the email publisher or administrator's API credentials which were stored during the ad unit setup process. Ideally this process would run on a scheduled basis and using the given ESP API functions, would retrieve a list of defined campaigns or mailings in the email publisher's ESP account. For each mailing the email publisher has defined, the ESP API is leveraged to retrieve the subject line, HTML, text and other available attributes of the mailing. The HTML, text, subject and other attributes are then cataloged and stored in a central data store. The cataloging process performed by the creative crawling process, 12, may include analyzing and storing keyword frequency and density to be used by the dynamic image serving process, 13.

The creative crawling process, 12, may also be triggered by the dynamic image serving process, 13. This would occur when a new campaign Id is discovered by the dynamic image process, 13, for an ESP integration that has not been cataloged. In this case, an on-demand process may be leveraged to retrieve and catalog the creative as described above.

In the case the email publisher or administrator does not leverage a pre-defined ESP, the dynamic image serving process, 13, would also serve as a trigger for the creative crawling process, 12. In this case, the dynamic image serving process, 13, would examine the campaign Id of the mailing passed in by the mailer when the dynamic image serving process encounters a campaign Id it has yet to catalog. In such case, the creative crawling process, 12, retrieves the lookup URL provided by the email publisher or administrator during the ad unit setup process and programmatically visits this URL to retrieve, catalog and save the creative in the creative data store. An example of this process is provided below:

### Ad Unit Image:

<img src=“http://e-find.co/img/1?CampaignId=8”/>

### Email Publisher Provided Lookup Link:

http://mailercreativelookup.com/LookupCampaignId=[[Id]]

In this example, the image serving process, 13, receives an image serving request for add unit “1” above. The image serving process, 13, checks the mailing creative data store for the creative for campaign “8” for this ad unit. However, in the case this campaign has not been cataloged a signal is sent to the creative crawling process, 12, to retrieve the creative for this campaign. The process then retrieves the lookup URL provided by the email publisher or administrator during the ad unit setup process, as indicated in the above example. A replacement is done in the provided URL using the campaign Id “8” to form a URL of http://mailercreativelookup.com/LookupCampaignId=8 by replacing the placeholder variable [[Id]] with the campaign Id passed into the image serving process, 13. The creative crawling process, 12, then visits the URL where the email publisher has posted a copy of their campaign creative. It then programmatically retrieves, catalogs and stores the creative in the mailing creative data store and associates it with the given ad unit Id in the same manner as described above.

Alternatively, rather than retrieving content via an Email Service Provider API or previously stored URL, the ad unit code may be altered to accept the URL of an online version of the email content as follows:
<a href=“http://e-find.co/c/1?CampaignId=8&EmailId=123456&onlineurl=http%3A%2F%2Fwww.viewthisemailonline.com%2F%3Femail%3D1”><imgsrc=“http://e-find.co/img/1?CampaignId=8&EmailId=123456&http%3A%2F%2Fwww.viewthisemailonline.com%2F%3Femail%3D1”/></a>

The URL passed in for the image URL would then be used as the basis for the Creative Crawling Process, 12.

### Example 4

### Dynamic Image Serving

When a user receives an email with the ad unit code defined in the ad unit setup process, 11, the HTML image code for the ad unit is triggered when the email is viewed. An example of this ad unit code and image URL rendered in a recipient's email, is as follows:
<a href=“http//e-find.co/c/1?CampaignId=8&EmailId=123456”><img src=“http://e-find.co/img/1?CampaignId=8&EmailId=123456”/></a>

In the example above, “1” is the unique identifier of the ad unit and “8” is the unique mailing Id of the mailing injected by the ESP or other mail initiator programmatically as the mail is sent to the user. Likewise, “123456” is an optional unique identifier of the recipient also injected by the ESP or other mail initiator programmatically as the mail is sent.

When the image load request is made to the dynamic image serving process, 13, the unique identifier for the ad unit is used to look up information about the ad unit in order to determine what advertisement image to return. Additionally, the mailing Id injected as the mail is sent is used to retrieve the creative content attributes for this mailing stored in the mailing creative data store by the creative crawling process, 12.

As detailed in the ad unit set up process, 11, specific advertisements may have been defined for display or advertisements may be dynamically selected from a pool of available advertisements. The process of selecting the image and advertisement includes analyzing the content or cataloged keywords of the creative as retrieved and stored by the creative crawling process, 12. Additional contextual information may also be used in addition to the content of the creative itself in selecting the most appropriate advertising image, including geo location based on a user's IP address, device type or even specific user information based on unique identifiers passed in the ad unit image URL (for example, their email address).

In view of the foregoing, it will be seen that several advantages of the present disclosure are achieved and attained. The embodiments were chosen and described in order to best explain the principles of the invention and its practical application to thereby enable others skilled in the art to best utilize the invention in various embodiments and with various modifications as are suited to the particular use contemplated. As various modifications could be made in the constructions and methods herein described and illustrated without departing from the scope of the invention, it is intended that all matter contained in the foregoing description or shown in the accompanying drawings shall be interpreted as illustrative rather than limiting. For example, the timing and method of cataloging creatives and analyzing content may be performed real time as image requests or received or performed once as the creative is received.

What is claimed is:

1. A method for providing contextual advertising in an email, comprising:
providing, using one or more computing devices, an ad unit identifier corresponding to an ad unit in an email to a user;
providing, using one or more computing devices, a campaign identifier corresponding to a template associated with the email to the user;
generating, using the one or more computing devices, an ad image load request when the user views the user views the email, the ad image load request comprising the ad unit identifier, the campaign identifier, and at least one user identifier;
retrieving, using the one or more computing devices, an ad image corresponding to the ad unit identifier in response to the ad unit image load request, the ad image dynamically selected from a pool of available advertisement images corresponding to the ad unit based on the campaign identifier and user identifier;
displaying, using the one or more computing devices, the ad image in the email; and
recording, using the one or more computing devices, the ad image and the at least one user identifier in an impression data store.

2. The method of claim 1, further comprising:
storing, using the one or more computing devices, the ad unit and ad unit information in a data store; and
storing, using, using the one or more computing devices, the template in the data store, wherein the ad unit comprises at least two advertisements.

3. The method of claim 2, further comprising:
retrieving, using the one or more computing devices, the template corresponding to the campaign identifier;
analyzing, using the one or more computing devices, the template to identify one or more keywords; and
storing, using the one or more computing devices, the one or more keywords in the data store,
wherein the keywords inform the dynamic selection of the ad image from the ad unit.

4. The method of claim 1, further comprising:
providing, using the one or more computing devices, an online email URL associated with an online viewable email corresponding to the email to the user;
storing, using the one or more computing devices, the ad unit and ad unit information in a data store; and
storing, using the one or more computing devices, the online viewable email in the data store,
wherein the ad unit comprises at least two advertisements.

5. The method of claim 2, further comprising:
retrieving, using the one or more computing devices, the online viewable email associated with the online email identifier;
analyzing, using the one or more computing devices, the online viewable email to identify one or more keywords; and
storing, using the one or more computing devices, the one or more keywords in the data store,
wherein the keywords inform the dynamic selection of the ad image from the ad unit.

6. The method of claim 1, further comprising:
retrieving, using the one or more computing devices, a redirect URL corresponding to the ad image; and
returning, using the one or more computing devices, the redirect URL to the user.

7. The method of claim 2, further comprising:
retrieving, using the one or more computing devices, an email service provider from a publisher for the template; and
storing, using the one or more computing devices, the email service provider of the publisher in the data store.

8. The method of claim 7, further comprising:
retrieving a lookup URL from the publisher; and
retrieving the template from the lookup URL when the email service provider is unknown.

9. The method of claim 2, wherein the ad unit information is selected from a group consisting of size of the advertisements, number of advertisements, types of advertisements, specific advertisements, ad images, ad colors, ad layouts, negative keyword targets, and combinations thereof.

10. The method of claim 1, further comprising providing, using one or more computing devices, a recipient identifier corresponding to the user.

11. The method of claim 10, further comprising creating an ad unit code comprising at least one of the ad unit identifier, the campaign identifier, and the recipient identifier.

12. The method of claim 1, wherein the at least one user identifier is selected from the group consisting of an impression date, an impression time, a user IP address, a user agent, a user device, a user email address, a derivative of the user email address, a user location, a randomly generated number, a randomly generated variable, and combinations thereof.

13. The method of claim 1, wherein the template comprises a subject line, an HTML portion, a text portion, and any combination thereof.

14. A system for providing contextual advertising in an email, comprising:
at least one processor,
a dynamic ad application comprising a plurality of modules executable on the at least one processor, the plurality of modules comprising:
an image load request module to identify an ad unit image load request generated by a user viewing the email, the ad image load request comprising an ad unit identifier corresponding to an ad unit, a campaign identifier corresponding to a template associated with the email to the user, and at least one user identifier;
a dynamic ad unit lookup module to retrieve an ad image corresponding to the ad unit identifier in response to the ad unit image load request, the ad image dynamically selected from a pool of available advertisement images corresponding to the ad unit based on the campaign identifier and user identifier;
an image serving module to display the ad image to the user; and
an impression recording module for identifying the ad image displayed to the user and recording the ad image and the at least one user identifier in an impression data store.

15. The system of claim 14, wherein the plurality of modules further comprise:
an ad unit definition module comprising a data store for storing the ad unit and ad unit information;
a unique identifier module for assigning the ad unit identifier to the ad unit, assigning the campaign identifier to the template, and storing the ad unit identifier and campaign identifier in the data store; and
a campaign module for storing the template in the data store.

16. The system of claim 15, wherein the plurality of modules further comprise:
a template module for retrieving the template corresponding to the campaign identifier;
a crawling module for analyzing the template to identify one or more keywords; and
a creative module for storing the one or more keywords in the data store,
wherein the keywords inform the dynamic selection of the ad image from the ad unit.

17. The system of claim 15, wherein:
the ad image load request further comprises an online email URL associated with to an online viewable email corresponding to the email;
an online email module for retrieving the online viewable email associated with the online email URL; and
the plurality of modules further comprise:
a crawling module for analyzing the online viewable email to identify one or more keywords; and
a creative module for storing the one or more keywords in the data store,
wherein the keywords inform the dynamic selection of the ad image from the ad unit.

18. The system of claim 14, wherein the plurality of modules further comprise:
a redirection lookup module for retrieving a redirect URL corresponding to the ad image; and
a redirection return module for returning the redirect URL to the user.

19. The system of claim 15, wherein the plurality of modules further comprises:
an ESP module for retrieving an email service provider from a publisher for the template; and
an ESP storage module for storing the email service provider of the publisher in the data store.

20. The system of claim 19, wherein the plurality of modules further comprise:
a lookup module for retrieving a lookup URL from the publisher; and
a template lookup module for retrieving the template from the lookup URL when the email service provider is unknown.

21. The system of claim 15, wherein the ad unit information is selected from the group consisting of size of the advertisements, number of advertisements, types of advertisements, specific advertisements, ad images, ad colors, ad layouts, negative keyword targets, and combinations thereof.

22. The system of claim 15, wherein the unique identifier module further comprises assigning a recipient identifier corresponding to the user.

23. The system of claim 22, the plurality of modules further comprises an ad unit code module for creating an ad unit code comprising at least one of the ad unit identifier, the campaign identifier, and the recipient identifier.

24. The system of claim 14, wherein the at least one user identifier is selected from the group consisting of an impression date, an impression time, a user IP address, a user agent, a user device, a user email address, a derivative of the user email address, a user location, a randomly generated number, a randomly generated variable, and combinations thereof.

25. The system of claim 14, wherein the template comprises a subject line, an HTML portion, a text portion, and any combination thereof.
